(19) United States
(12) Patent Application Publication
(10) Pub. No.: US 2013/0007625 A1
(43) Pub. Date: Jan. 3, 2013

(54) APPARATUS, SYSTEM, AND METHOD FOR CONNECTING MOBILE DEVICES TO A BACKEND SERVER IN AN ENTERPRISE SOFTWARE ENVIRONMENT AND INITIATING A BUSINESS PROCESS

(76) Inventors: Victor Lozinski, Los Altos, CA (US); Arthur Lozinski, Los Altos, CA (US)

(21) Appl. No.: 13/426,421

(22) Filed: Mar. 21, 2012

Related U.S. Application Data
(60) Provisional application No. 61/454,898, filed on Mar. 21, 2011.

(51) Int. Cl. G06Q 10/06; G06F 21/00; G06F 15/16; G06F 3/01

(52) U.S. Cl. 715/738; 715/753; 726/11; 705/348

(57) ABSTRACT

An apparatus, system, and computer-implemented method are disclosed for connecting a mobile device to a backend server. The backend server includes a processor, a memory, and an input/output interface for receiving and transmitting information to and from the processor. The method comprising capturing information using a mobile device; providing the captured information to the backend server; creating a document in the backend server that includes the captured information; associating the document with a business object; and initiating a business process in accordance with the business object and the recorded information.

### CROSS-REFERENCE TO RELATED APPLICATION

This application claims the benefit under Title 35, United States Code §119(e), of U.S. Provisional Patent Application Ser. No. 61/454,898, filed Mar. 21, 2011 and entitled “APPARATUS, SYSTEM, AND METHOD FOR CONNECTING MOBILE DEVICES TO A BACKEND SERVER IN AN ENTERPRISE SOFTWARE ENVIRONMENT AND INITIATING A BUSINESS PROCESS,” the disclosure of which is hereby incorporated by reference in its entirety.

### BACKGROUND

In one aspect, the present disclosure relates generally to a client and server apparatus, system, and method for connecting mobile devices to a backend server in an enterprise software environment. More specifically, the present disclosure relates to an apparatus, system, and method for creating a document in the backend server that includes information captured by a mobile device, associating the document with a business object, and initiating a business process in accordance with the business object.

Software used by business organizations or governments, rather than software chosen by individual users (e.g., retail software), is generally referred to as enterprise software or enterprise application software (EAS). Such enterprise software is an integral component of a Computer Based Information System and provides a variety of services and business-oriented tools. Such business-oriented services and tools may include, for example, online shopping and online payment processing, interactive product catalogue, automated billing systems, security, content management, information technology (IT) service management, customer relationship management, resource planning, business intelligence, human resources (HR) management, manufacturing, plant maintenance, application integration, and forms automation.

In an enterprise application software environment, enterprise application software performs business functions such as order processing, procurement, production scheduling, customer information management, and accounting. It is typically hosted on servers, also known as backend servers, and provides simultaneous services to a large number of users, typically over a computer network such as a Wide Area Network (WAN) and increasingly over the Internet. An enterprise software environment is in contrast to single-user applications that are executed on a user's personal computer and serves only a single user at a time.

In recent years, the use of wireless technology, also known as mobile technology, has exploded. The availability of mobile technology has dramatically increased the ability of individuals in business organizations to conduct business away from the office. With mobile technology, a user can use laptops, wireless phones, smart phones, personal digital assistants (PDA), notepad computers, and notebook computers to keep track and in touch with other users, the home office, customers, filed sales force, among others. In an enterprise application software environment, it would be desirable to combine the mobility provided by mobile technology to capture information in the field using a mobile device, record such information at a backend server, and initiate a business process in the backend server according to the recorded information.

### SUMMARY

In one aspect, a computer-implemented method for connecting a mobile device to a backend server. The computer comprises a processor, a memory, and an input/output interface for receiving and transmitting information to and from the processor. The computer provides an execution environment for executing a set of instructions for capturing information using a mobile device, providing the captured information to a backend server, and initiating a business process in accordance with the recorded information.

In another aspect, the computer-implemented method further includes creating a document in the backend server that includes the captured information, associating the document with a business object, and initiating a business process in accordance with the business object and the recorded information.

### FIGURES

FIG. 1 is a system for connecting a mobile device to a backend server.

FIG. 2 illustrates multiple configurations of a mobile device.

FIG. 3 illustrates a mobile device displaying one aspect an objects screen.

FIG. 4 illustrates the mobile device of FIG. 3 displaying one aspect of a description screen.

FIG. 5 illustrates the mobile device of FIGS. 3-4 displaying one aspect of a link description screen.

FIG. 6 illustrates the mobile device of FIGS. 3-5 displaying one aspect of a media description screen.

FIG. 7 illustrates the mobile device of FIGS. 3-6 displaying one aspect of an uploading screen.

FIG. 8 illustrates a location screen displayed by the mobile device of FIGS. 3-7.

FIG. 9 illustrates a “Success!” screen displayed by the mobile device of FIGS. 3-8.

FIG. 10 illustrates an “Audio” screen displayed by the mobile device of FIGS. 3-9.

FIG. 11 illustrates an “Uploading” screen displayed by the mobile device of FIGS. 3-10.

FIG. 12 illustrates one aspect of a mobile device connected to a backend server.

FIG. 13 illustrates a screen displayed by the mobile device of FIG. 12 for entering a report and location information.

FIG. 14 illustrates a map integration screen displayed by the mobile device of FIGS. 12-13.

FIG. 15 illustrates a graphical screen displayed by the backend server on a display coupled to the backend server.

FIG. 16 illustrates a graphical screen displayed by the backend server on the display coupled to the backend server.

FIG. 17 illustrates a graphical screen displayed by the backend server on the display coupled to the backend server.

FIG. 18 illustrates a graphical screen displayed by the backend server on the display coupled to the backend server.

FIG. 19 illustrates a mobile device, which is similar to the mobile devices shown in FIGS. 1-18, displaying one aspect of a “Key Fields” screen comprising a “Document Fields” portion and a keyboard portion for manual data entry by the user.

FIG. 20 is a diagram of a computer-implemented process for connecting a mobile device with a backend server and initiating a business process.

FIG. 21 is a diagram of one aspect of a system associated with a distributed collaborative network.

FIG. 22 illustrates a graphical screen displayed by the backend server on the display coupled to the backend server.

FIG. 23 illustrates an example environment for implementing various aspects of the backend server shown in FIG. 1.

FIGS. 24 and 25 illustrate specific implementations of a backend server environment shown in FIG. 1.

### DESCRIPTION

The present disclosure describes various aspects of a computer-implemented client and server apparatus, system, and method for connecting mobile devices to a backend server in an enterprise software environment. In one aspect, the present disclosure describes an apparatus, system, and method for capturing information using a mobile device, providing the captured information to a backend server, and initiating a business process in accordance with the recorded information. In another aspect, the present disclosure describes an apparatus, system, and method fro creating a document in the backend server that includes the information captured by the mobile device, associating the document with a business object, and initiating a business process in accordance with the business object and the recorded information. In one aspect, the apparatus, system, and method are described in the context of an enterprise application software environment. Nevertheless, the present disclosure is not limited in this context and may be applicable to any system capable of combining the mobility provided by mobile technology for capturing information in the field using a mobile device, recording such information at a backend server, and initiating a business process in the backend server according to the business object and the recorded information. Still further, the system should be capable of creating a document comprising the captured information, associating the document with a business object, and initiating a business process in accordance with the business object and the recorded information.

Aspects of the computer-implemented system and method are described herein in the context of executable software programs developed and managed within an enterprise software platform. In one aspect, the enterprise software platform includes enterprise software applications such as those provided by SAP® AG of Walldorf, Germany that support businesse enterprises of all sizes globally. The SAP® enterprise application software includes, but is not limited to, the SAP® Enterprise Resource Planning (SAP ERP), SAP® ERP Central Component (ECC), SAP® BusinessObjects software, SAP NetWeaver™, and SAP Mobile Infrastructure, among others. Nevertheless, the techniques disclosed herein are not limited as such and are considered extensible to other enterprise software platforms and environments, without limitation.

Although various techniques may be described hereinbelow in the context of a specific enterprise software platform, the scope of such techniques are not limited thereto. Accordingly, it is to be understood that this disclosure is not limited to particular aspects or embodiments described herein, as such may vary. It is also to be understood that the terminology used herein is for the purpose of describing particular aspects or embodiments only, and is not intended to be limiting, since the scope of the computer-implemented apparatus, system, and method for connecting mobile devices to a backend server is defined solely by the appended claims.

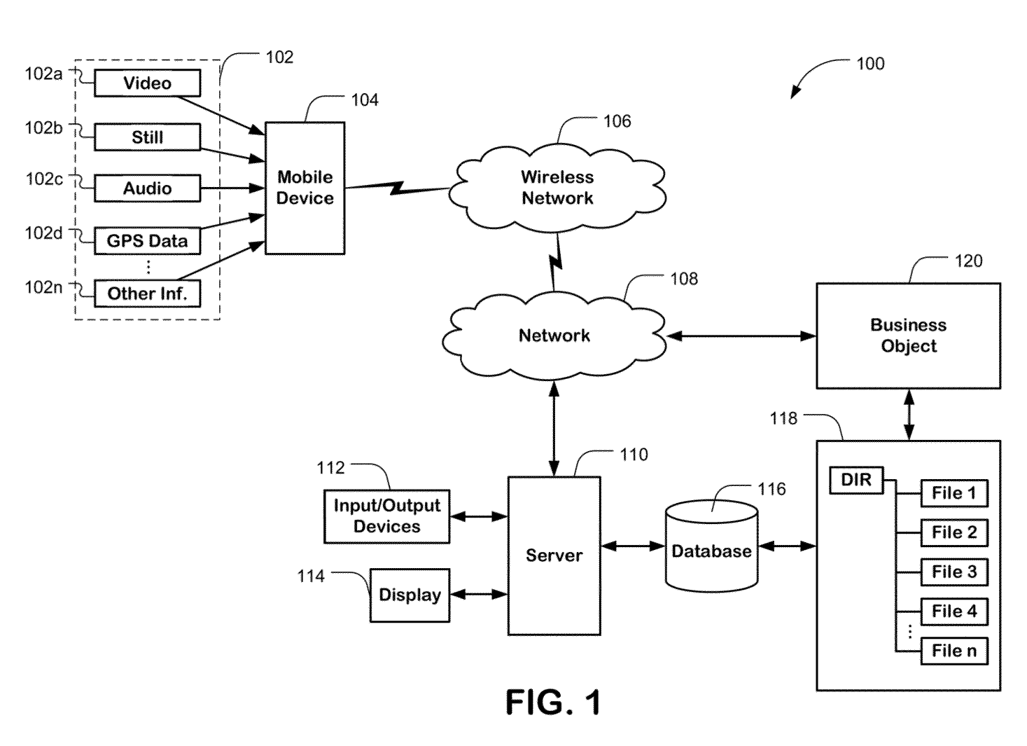

FIG. 1 is a system 100 for connecting a mobile device 104 to a backend server 110. According to the illustrated system 100, information 102 captured by the mobile device 104 is transferred to the backend server 110 through one or more communication networks such as wireless network 106 and network 108 (e.g., Internet/WAN). Once the information 102 is received by the backend server 110, the server 110 creates a document 118 that includes the information, associates the document 118 with a business object 120, and initiates a business process according to the business object 120 and/or the recorded information 102. In one aspect, the wireless network 106 and the network 108 may be a single network, for example.

In various aspects, the information 102 recorded or captured by the mobile device 104 may take many forms and may be referred to as media, multimedia, and/or content. The multimedia information 102 includes any combination of video 102a, still images 102b, audio 102c, Global Positioning System (GPS) data 102d, and other information 102n such as text, animation, and interactivity content forms, among others. The multimedia information 102 may be recorded (captured) by the mobile device 104 and may be played, displayed or accessed by information content processing devices, such as computerized and electronic devices. In the illustrated system 100, the one or more forms of multimedia information 102 captured by the mobile device 104 may be transmitted directly to the backend server 110 or may be initially stored in a memory of the mobile device 104 and then a copy of the multimedia information 102 may be transmitted to the backend server 110. Once captured, the mobile device 104 converts the video 102a, still images 102b, audio 102c, GPS data 102d, and other information 102n such as text, animation, and interactivity content forms, into separate corresponding files, which can be stored and/or transmitted to the backend server 110 over the wireless network 106 and the network 108.

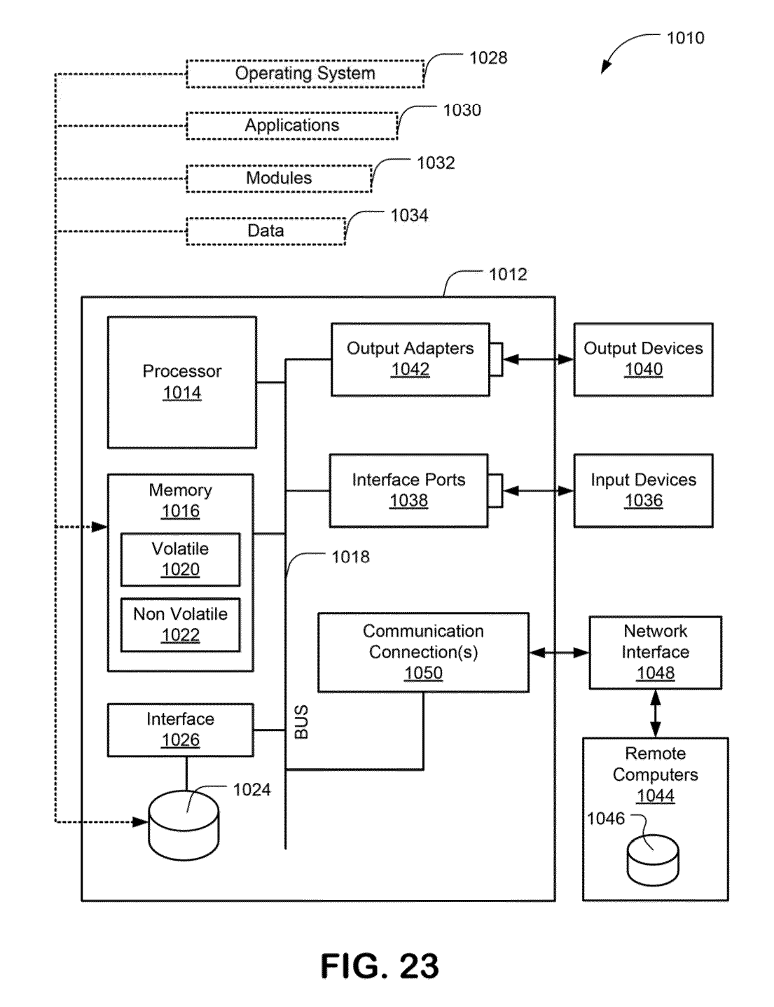

The backend server 100 is coupled to input/output devices 112, a display 114 (monitor), and a mass storage device 116, which may store a database, such as, for example, an enterprise database. In various aspects, the backend server 110 includes components and software that permit it to automatically access the information 102 from the mobile device 104. The backend server 110 may be configured to retrieve the information 102, review, monitor, and control certain aspects of the mobile device 104 in accordance with predefined executable software modules. The backend server 110 may be physically situated near the mobile device 104, or may be remote from it, such as in a business organization facility known as a back office, a factory, or even off-site, such as in a management office or data repository. The backend server 110 may include, among other components, a processor, a memory, and an interface (and is described in more detail in FIG. 23). A user may access the backend server 110 via the input/output devices 112 to configure various modules for receiving the captured information from the mobile device 104 at the backend server 110, creating the document 118 by the backend server 110 that includes the captured information 102, associating the document 118 with the business object 120, and initiating a business process in accordance with the business object 120 and/or the recorded information contained in the document 118. Specialized applications are executed by the processor to communicate with the mobile device 104 and other devices connected to the backend server 110. The memory is used for data storage and in one aspect may be coupled to the database 116.

The backend server 110 is operative to automatically receive the information 102 from the mobile device 104 and to store the information 102 in the form of one or more files: File 1, File 2, File 3, File 4, File n, in the document 118, which is stored in the memory or the database 116 coupled to the backend server 110. The one or more files File 1, File 2, File 3, File 4, File n correspond to the multimedia information 102 captured by mobile device 104, e.g., video 102a, still images 102b, audio 102c, GPS data 102d, and other information 102n such as text, animation, and interactivity content forms, among others. As shown, the document 118 is structured as a Document Information Record (DIR) with the one or more files: File 1, File 2, File 3, File 4, File n stored within the DIR.

Once the document 118 is created, the one or more files (File 1, File 2, File 3, File 4, File n) corresponding to the multimedia information 102 captured by the mobile device 104 (video 102a, still images 102b, audio 102c, GPS data 102d, and other information 102n such as text, animation, and interactivity content forms, among others) are inserted in the document 118 by the backend server 110 in a logical structure. The backend server 110 then automatically links the document 118 with the business object 120. In one aspect, a business object 120 is associated with a number of business functions such as order processing, procurement, production scheduling, customer information management, and accounting. More particularly, in various or aspects or in all aspects, a business object 120 may be an equipment master, a materials master, a customer master, vendor aster, service notification, bill of materials, or any business object within the context of the enterprise software application environment or other enterprise application software environments. In one aspect, the business object 120 comprises key fields and contains information in the form of metadata that associates the document 118 with the business object 120.

Once the business object 120 is associated with the document 118, the backend server 110 initiates a business process according to the business object and/or the recorded information. For example, in the context of the information 102 captured by the mobile device 104, the business process may take control of the mobile device graphical user interface (GUI) to display information consistently with the business object 120 rather than with the mobile device 104 GUI and allow data capture in accordance with the underlying enterprise application software environment.

In various aspects, the wireless network 106 (e.g., wireless network node) may provide voice and/or data communications functionality in accordance with different types of cellular radiotelephone systems. Examples of cellular radiotelephone systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), CDMA-2000, 4G systems that provide a comprehensive and secure all-IP based mobile broadband solution to laptop computer wireless modems, smartphones, and other mobile devices, Universal Mobile Telephone System (UMTS) systems, WiMAX (Worldwide Interoperability for Microwave Access, LTE (Long Term Evolution) and so forth.

In various embodiments, the wireless network 106 may be configured to provide voice and/or data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.1a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. A mobile computing device may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques.

Vehicles of communication between the mobile device 104 and the backend server 110 include the network 108 (e.g., network node). In various aspects, the network 108 comprises local area networks (LAN) as well as WAN including without limitation Internet, wired channels, wireless channels, communication devices including telephones, computers, wire, radio, optical or other electromagnetic channels, and combinations thereof, including other devices and/or components capable of/associated with communicating data. For example, the communication environments include in-body communications, various devices, various modes of communications such as wireless communications, wired communications, and combinations of the same.

Wireless communication modes include any mode of communication between points that utilizes, at least in part, wireless technology including various protocols and combinations of protocols associated with wireless transmission, data, and devices. The points include, for example, wireless devices such as wireless headsets, audio and multimedia devices and equipment, such as audio players and multimedia players, telephones, including mobile telephones and cordless telephones, and computers and computer-related devices and components, such as printers.

Wired communication modes include any mode of communication between points that utilizes wired technology including various protocols and combinations of protocols associated with wired transmission, data, and devices. The points include, for example, devices such as audio and multimedia devices and equipment, such as audio players and multimedia players, telephones, including mobile telephones and cordless telephones, and computers and computer-related devices and components, such as printers.

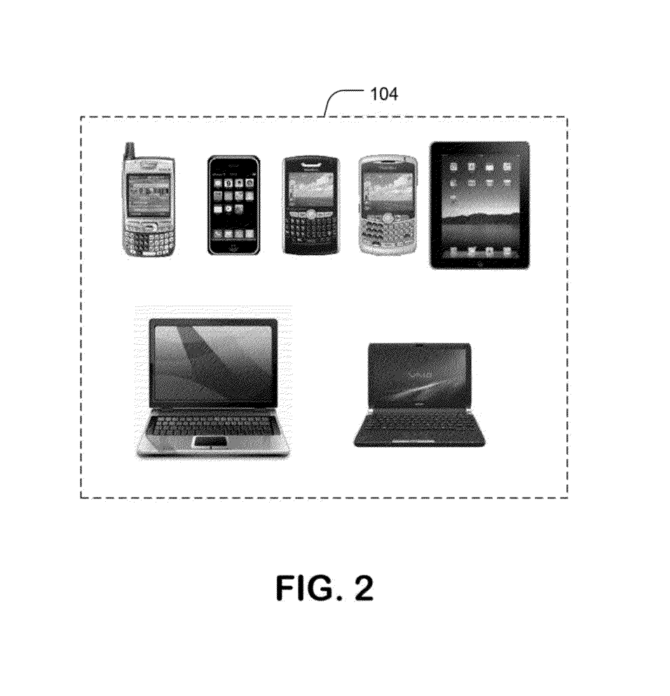

FIG. 2 illustrates multiple configurations of a mobile device. As shown in FIG. 2, the mobile device 104 may include, for example, any device such as a short-range, portable electronic device used for mobile voice or data communication over a network 106 of specialized cell site base stations. Broad categories of the mobile device 104 include, for example, base stations, personal communication devices, handheld devices, and mobile telephones. The mobile device 104 is sometimes known as or referred to as a “mobile,” “wireless,” “cellular phone,” “cell phone,” “hand phone (HP),” “smartphone.” In various aspects, the mobile device 104 may be implemented as a handheld portable device, computer, mobile telephone, sometimes referred to as a smartphone, tablet personal computer (PC), tablet device such as the iPad® tablet computer by Apple®, laptop computer, notebook computer, desktop computer, kiosk, or any combination thereof. Examples of smartphones include, for example, Palm® smartphones, Blackberry® smart phones, Apple® iPhone®, and the like, capable of capturing and transmitting one or more forms on information 102. Although some aspects of the mobile device 104 may be described with a mobile or fixed computing device implemented as a smartphone, personal digital assistant, laptop, or desktop computer by way of example, it may be appreciated that the various aspects are not limited in this context. For example, a mobile computing device may comprise, or be implemented as, any type of wireless device, mobile station, or portable computing device with a self-contained power source, e.g., battery, such as an ultra-laptop computer, personal digital assistant (PDA), combination cellular telephone/PDA, mobile unit, subscriber station, user terminal, portable computer, handheld computer, palmtop computer, wearable computer, media player, pager, messaging device, data communication device, and so forth. A fixed computing device, for example, may be implemented as a desk top computer, workstation, client/server computer, and so forth.

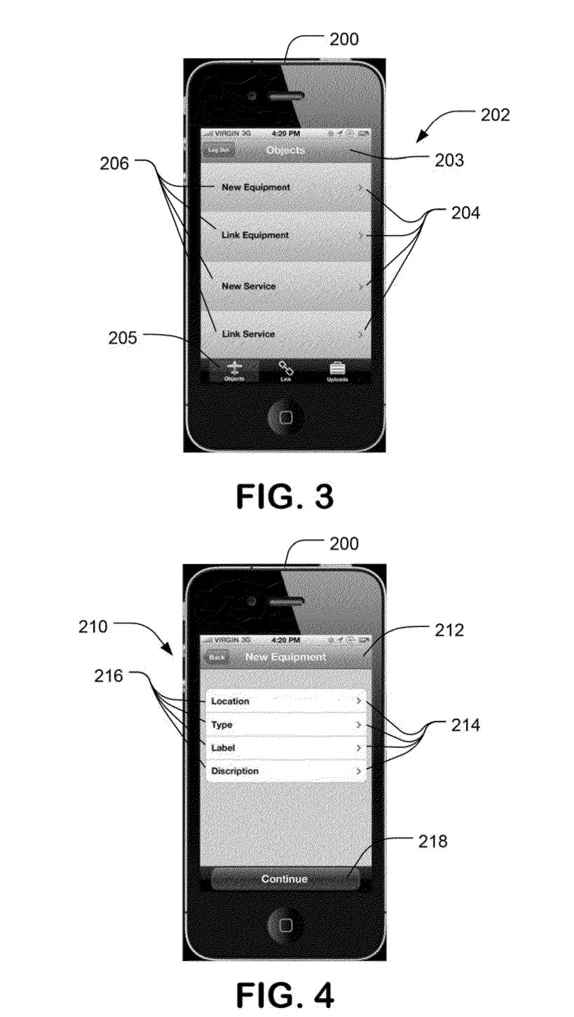

FIGS. 3-11 illustrate a series of steps for connecting a mobile device to a backend server in an enterprise application software environment. FIG. 3 illustrates a mobile device 104 displaying one aspect of an objects screen 202. Turning now to FIGS. 1 and 3, a mobile device 200, which can be any of the mobile devices 104 described in connection with FIGS. 1 and 2, is shown with an object screen 202 being displayed by the mobile device 200 GUI, as indicated by the “Objects” text 203 at the top and “Objects” icon 205 at the bottom of the objects screen 202. The objects screen 202 provides a plurality of elements 204 to select which business objects 120 are to be created and/or linked to the document 118 record in the backend server 110 to perform business functions such as order processing, procurement, production scheduling, customer information management, accounting, and the like. In various aspects, the elements 204 may be implemented as GUI elements, virtual buttons, mechanical buttons or switches, electromechanical buttons or switches, or any combinations thereof, and the like. In one aspect, the elements 204 are implemented as virtual buttons to select SAP® Business Objects that are created or linked to the DIR in the SAP® system, for example.

Still with reference to FIGS. 1 and 3, the elements 204 displayed on the objects screen 200 contain text 206 that associate the element 204 with the object 120 and a link to the document 118 associated with the object 120 in the backend server 110 system such as, for example, “New Equipment,” “Link Equipment,” “New Service,” and “Link service.” In one aspect, the text 206 can be changed to any text from the backend server 110. For illustration purposes, selecting the “New Equipment” virtual button element 204 invokes a description screen associated with the “New Equipment” object as shown with reference to FIG. 4.

FIG. 4 illustrates the mobile device of FIG. 3 displaying one aspect of a description screen 210. Accordingly, with reference now to FIGS. 1, 3, and 4, having selected the “New Equipment” virtual button element 204 in the objects screen 202, the mobile device 200 GUI now displays a “New Equipment” 212 description screen 210. The GUI now displays a plurality of fields 214 associated with the “New Equipment” object 212. These fields 214 create “classifications” in the information record of the document 118 and these fields are linked to fields in the business object 120. As previously described, in the context of an SAP® enterprise application software environment, the fields create classification in the SAP® “document Info Record” and are linked to fields in the SAP® “Business Objects.”

As shown in FIG. 4, the fields 214 associated with the “New Equipment” object 212 are labeled with descriptive text 216 “Location,” “Type,” “Label,” and “Description,” which can be changed to any text from the backend server 110. Tapping the “Continue” virtual button element 218 takes the user to the next screen as shown in FIG. 5.

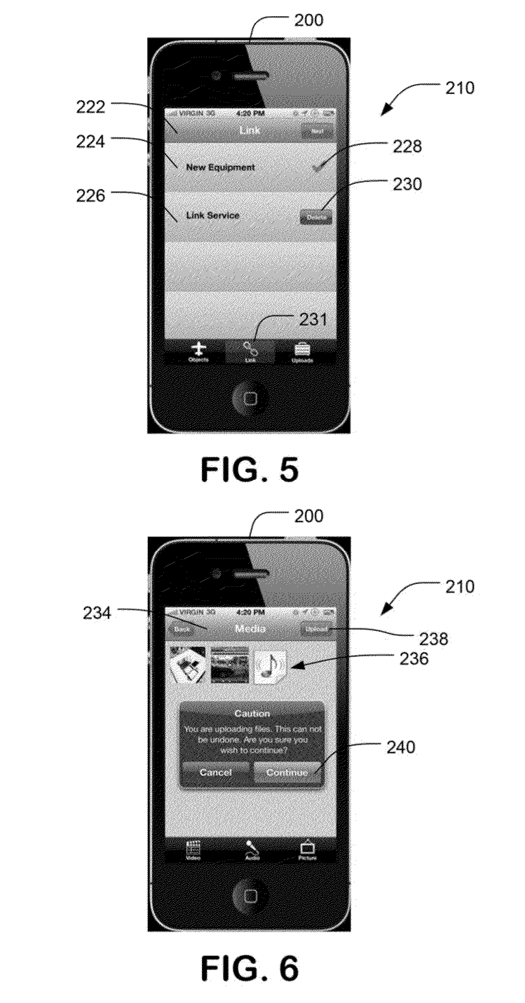

FIG. 5 illustrates the mobile device of FIG. 4 displaying one aspect of a link description screen 222. Accordingly, with reference now to FIGS. 1, 3, 4, and 5, having selected the “Continue” virtual button element 218, the mobile device 200 GUI now displays a link description screen 222 to link the document 118 to the “New Equipment” object 212. This is also indicated by the “Link” icon 231 displayed at the bottom of the description screen 210. The GUI now displays a “New Equipment” virtual button element 224 and a “Link service” virtual button element 226. By activating the “New Equipment” virtual button element 224, the user can add media files to multiple objects 120. In one aspect, the media files can be added to multiple objects 120 one at a time the proper “description” can be added one at a time. These media files are represented as File 1, File 2, File 3, File 4, File n in the document 118 block diagram shown in FIG. 1. As previously discussed, the media File 1, File 2, File 3, File 4, File n are replicas of the media files created by the mobile device 104 in connection with the captured information 102. Using a swiping motion on an existing field calls the “Delete” virtual button element 230 to delete previously indicated fields. The checkmark 228 is displayed to indicate that all proper fields have been entered and the user is now ready for the media screen as shown in FIG. 6.

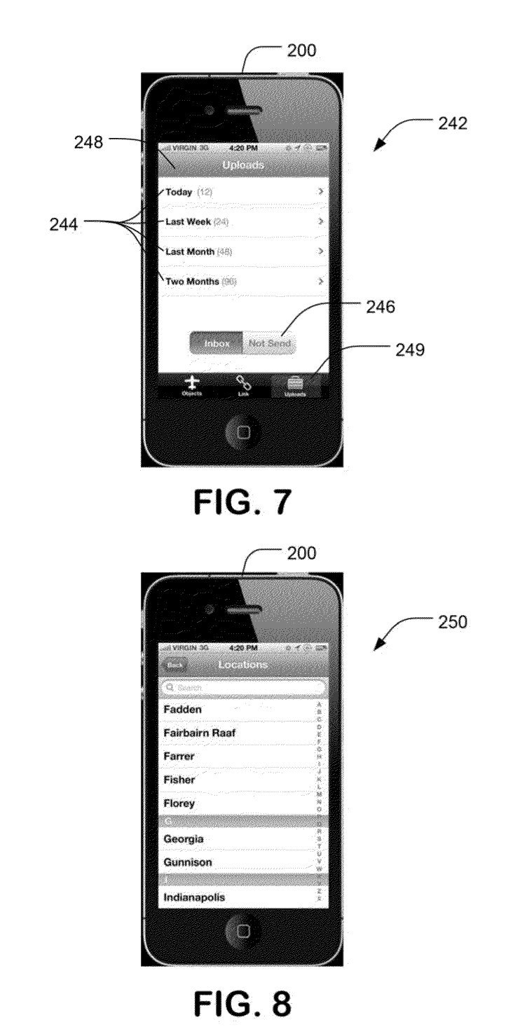

FIG. 6 illustrates the mobile device of FIG. 5 displaying one aspect of a media description screen 234. Accordingly, with reference now to FIGS. 1, 3, 4, 5, and 6, having entered all proper fields, the media description screen 234 is displayed by the mobile device 200 GUI as shown in FIG. 6. As shown in FIG. 6, thumbnails 234 that represent the content created by the mobile device 200 from the captured information 102 is shown in the media 234 screen. The thumbnails 234 will automatically refresh after the user has uploaded the files associated with the captured information 102 to the backend server 110 database 116. As shown in FIG. 6, the thumbnails represent, from left to right, a still image 1026, a video 102a, and audio 102c files captured by the mobile device 200. Tapping either the “Upload” virtual button element 238 or the “Continue” virtual button element 240 prompts the user to create or link the business object 120 and directory classifications as shown in the objects and description screen 210 and takes the mobile device 200 displays an upload screen as shown in FIG. 7.

FIG. 7 illustrates the mobile device of FIG. 6 displaying one aspect of an uploading screen 242. Accordingly, with reference now to FIGS. 1, 3, 4, 5, 6, and 7 having tapping either the “Upload” virtual button element 238 or the “Continue” virtual button element 240 shown in FIG. 6, the mobile device 200 displays an “Uploads” screen 242 as indicated by the “Uploads” text bar 248 at the top of the “Uploads” screen 242 and as indicated by the “Uploads” icon 249 at the bottom of the “Uploads” screen 242. In the illustrated aspect, the upload files 244 are categorized in chronological order. In other aspects, however, the upload files 244 may be categorized in any suitable order. When a network connection cannot be established either at the wireless network 106 or the network 108, the upload files 244 are stored as a draft, for example, as indicated by virtual element 246.

FIGS. 8-11 illustrate miscellaneous screens that can be displayed by the mobile device 200. FIG. 8 illustrates a location screen 250 displayed by the mobile device 200. As shown in FIG. 8, the locations screen 250 provides certain classifications that can be called from the backend server 110 (FIG. 1) enterprise application software environment, such as, for example the SAP® enterprise application software environment.

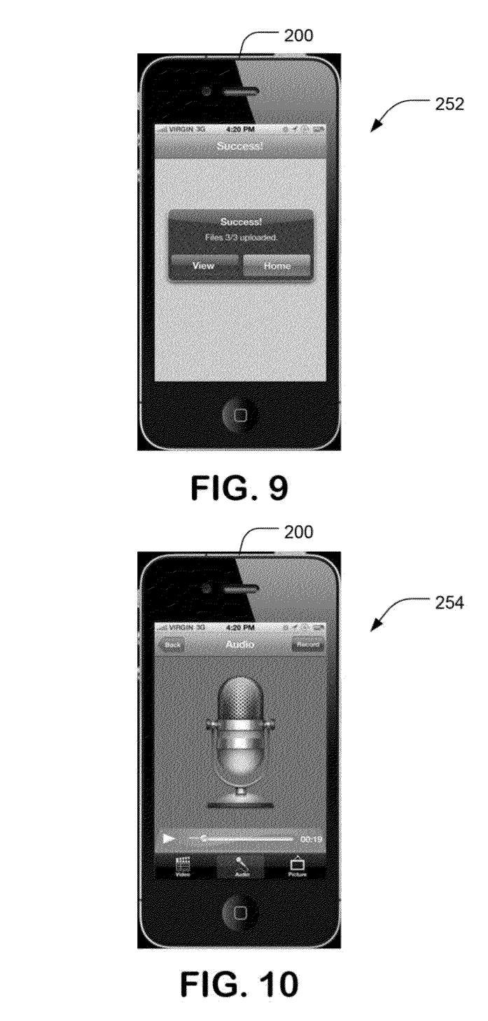

FIG. 9 illustrates a “Success!” screen 252 displayed by the mobile device 200. As shown in FIG. 9, the “Success!” screen 252 when the media files transferred to the backend server 110 (FIG. 1) are successfully stored in the database 116 (FIG. 1). Once stored, the files will retrievable either locally by the mobile device 200 or from the backend server 110.

FIG. 10 illustrates an “Audio” screen 254 displayed by the mobile device 200. As shown in FIG. 10, audio captured by the mobile device 200 can be recorded and played back directly on the mobile device 200.

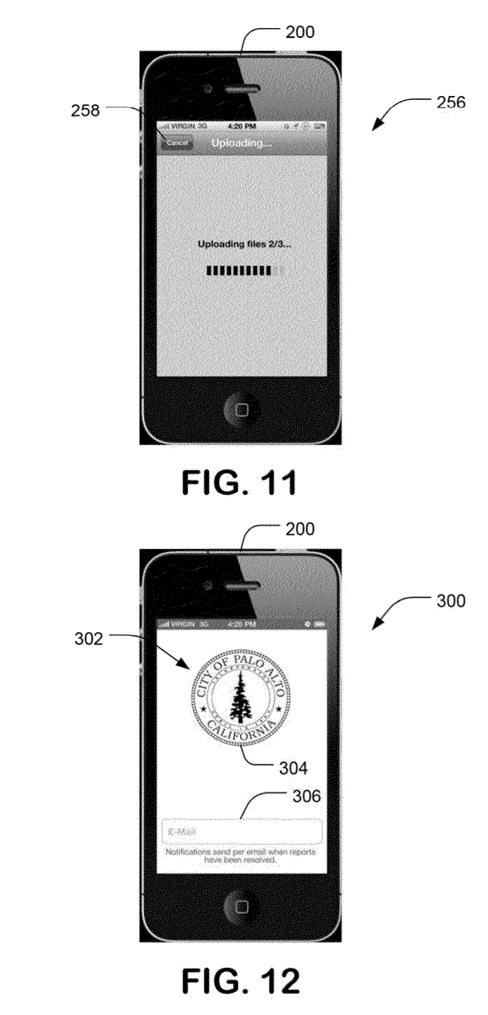

FIG. 11 illustrates an “Uploading” screen 256 displayed by the mobile device 200. The “Updating” screen 256 indicates that the files are being uploaded to the backend server 110 (FIG. 1). The uploading process can be canceled from within the upload screen by activating the “Cancel” virtual button element 258.

In various aspects, problems with a mobile application may be reported from the mobile device 200 by tapping and holding the touchscreen for a predetermined period of time, which can be customized via the mobile device 200 Settings. In one aspect, the predetermined period of time may be approximately 2 seconds. In other aspects, the predetermined period of time may be customized by the user via the mobile device 200 Settings. After the predetermined period of time, an OSS message will be created and the technical information in regards to memory and CPU-usage associated with the screenshot of the current running application will be automatically attached to it. A text description or voice memo of the problem may be added manually along with a movie, for example, which may be attached to the OSS message. Pushing the “Send” button sends the report. A ticket will be created in a cloud based information system and the ticket number will be displayed on the touchscreen of the mobile device 200.

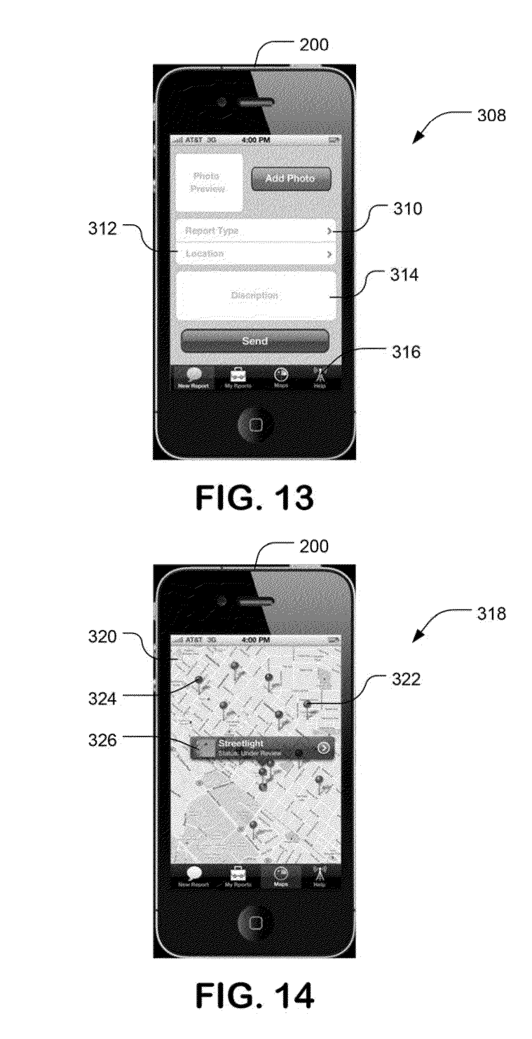

FIGS. 12-14 illustrate a particular implementation of the apparatus, system, and method for connecting a mobile device to a backend server and initiating a business process a in accordance with the present disclosure. FIG. 12 illustrates one aspect of a mobile device connected to a backend server. With reference now to FIGS. 1 and 12, the mobile device 200 is connected to the backend server 110 after taking a still image of a lamppost in a city, such as Palo Alto, Calif. The mobile device 200 captures a still image and GPS coordinates and uploads this information 102 to the backend server 110. The city logo 304 is called from the backend server 110. The backend server 110 determines the city from which the still image was taken based on the GPS coordinates, recalls the appropriate city logo 304, and displays the logo 304 on the screen 302 of the mobile device 200. A text box 306 is also called by the mobile device 200. By tapping “Done,” the user is taken to the next screen as shown in FIG. 13.

FIG. 13 illustrates a screen 308 displayed by the mobile device 200 for entering a report and location information. A “Report Type” virtual element 310 brings up a “Wheel” with choices when activated by the user. A “Location” virtual element 312 calls up a map with cross-hair to provide the exact location of either the user or the object that was imaged. Also, a keyboard pops up for the user to enter a description in a description portion of the screen 314. Activating the wireless network icon 316 displayed along a bottom portion of the screen 308 sends the captured information to the universal resource locator (URL) in the browser within the software application on the mobile device 200.

FIG. 14 illustrates a map integration screen 318 displayed by the mobile device 200. A map 320, which may be integrated with Google® Maps, for example, is displayed on the screen 318. The green pins 322 may be configured to indicate completed tasks whereas the red pins 324 may be configured to indicate tasks “under review.” A thumbnail 326 of the captured image is also displayed to provide the exact location of the object under review, which is a city street light currently under review.

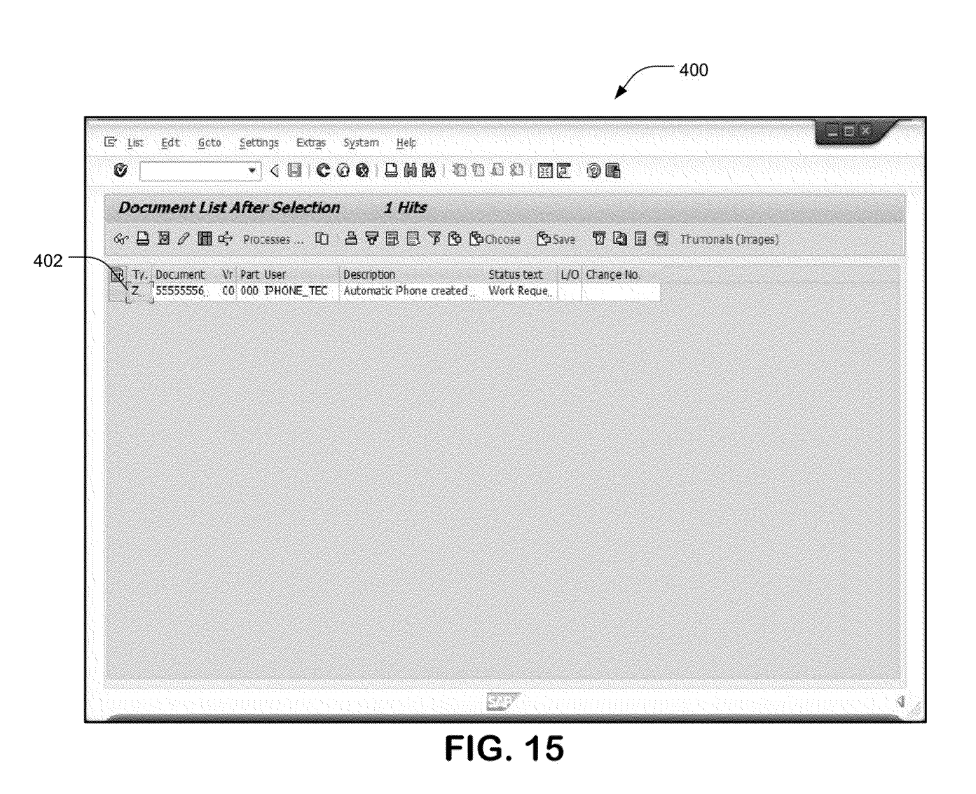

FIGS. 15-18 illustrate a variety of screens associated with the selection of documents as may be displayed by the backend server 110. FIGS. 15-19 will now be described in conjunction with FIG. 1. Accordingly, FIG. 15 illustrates a graphical screen 400 displayed by the backend server 110 on the display 114 coupled to the backend server 110. The screen 400 displays the selected document list. As shown, document 402 (named “55555556 . . . ”) is selected. The document 402 is created by the backend server 110 in accordance with information 102 files transferred to the backend server 110 by the mobile device 104.

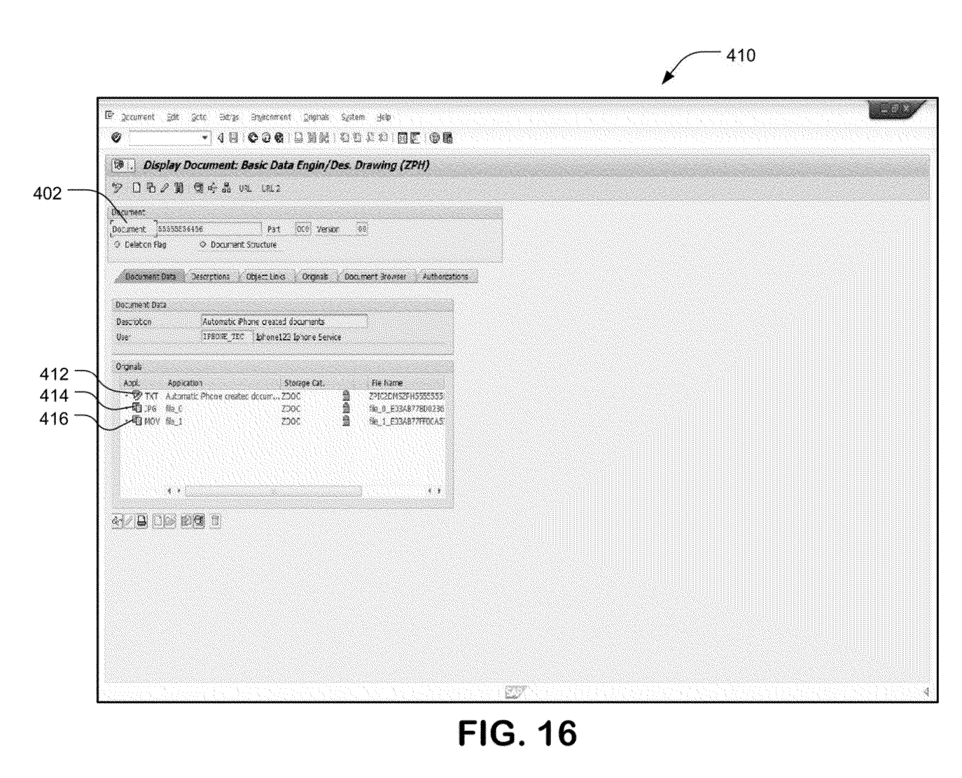

FIG. 16 illustrates a graphical screen 410 displayed by the backend server 110 on the display 114 coupled to the backend server 110. The screen 410 displays data associated with the document 402 (“55555556456”) selected in the screen 400. As shown, the selected document 402 (“55555556456”) includes a text file 412 (TXT extension) document comprising a still image file 414 (JPG extension) and a video file 416 (MOV extension). The text file 412 is the name of the document 118 created by the backend server 110, which includes the still image file 414 and the video file 416.

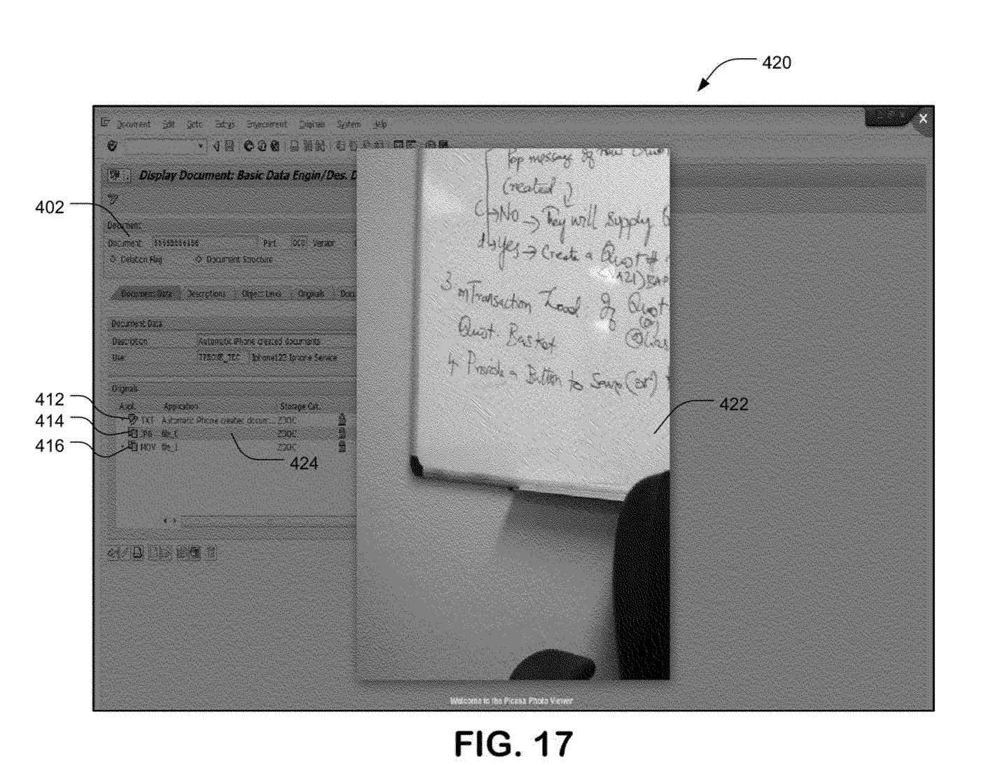

FIG. 17 illustrates a graphical screen 420 displayed by the backend server 110 on the display 114 coupled to the backend server 110. The screen 420 displays a still image 422 associated with the still image file 414 when the highlighted bar 424 is selected by the user.

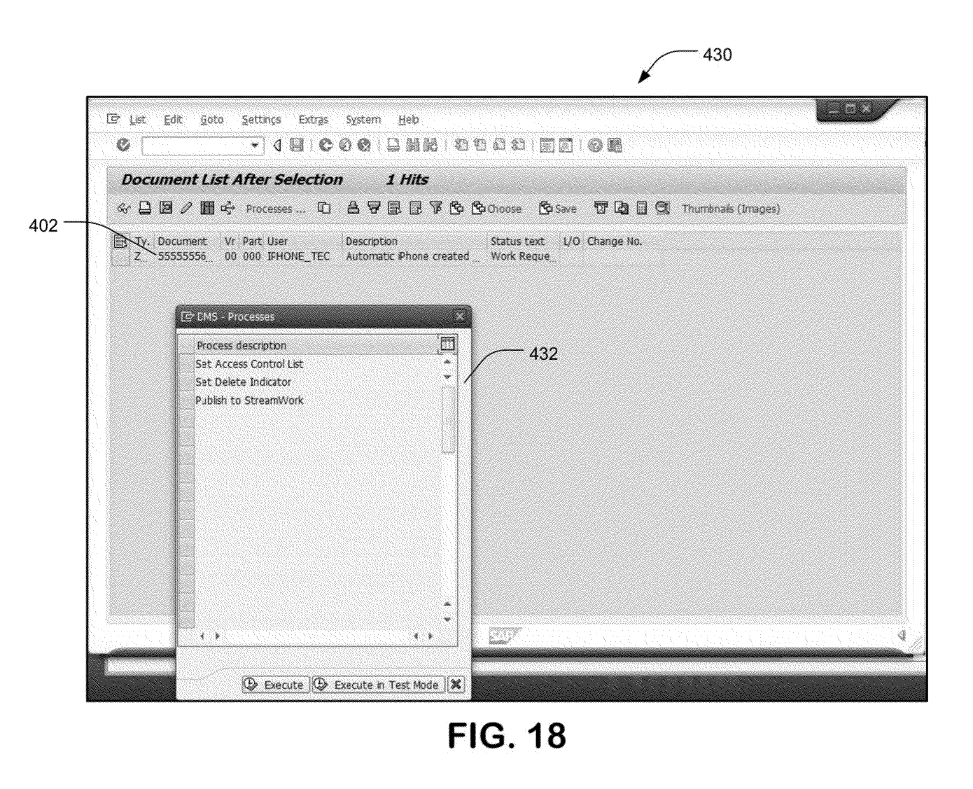

FIG. 18 illustrates a graphical screen 430 displayed by the backend server 110 on the display 114 coupled to the backend server 110. The screen 430 provides the document 402 list after selection and displays a processes screen 432 to indicate the status and process description associated with the selected document 402.

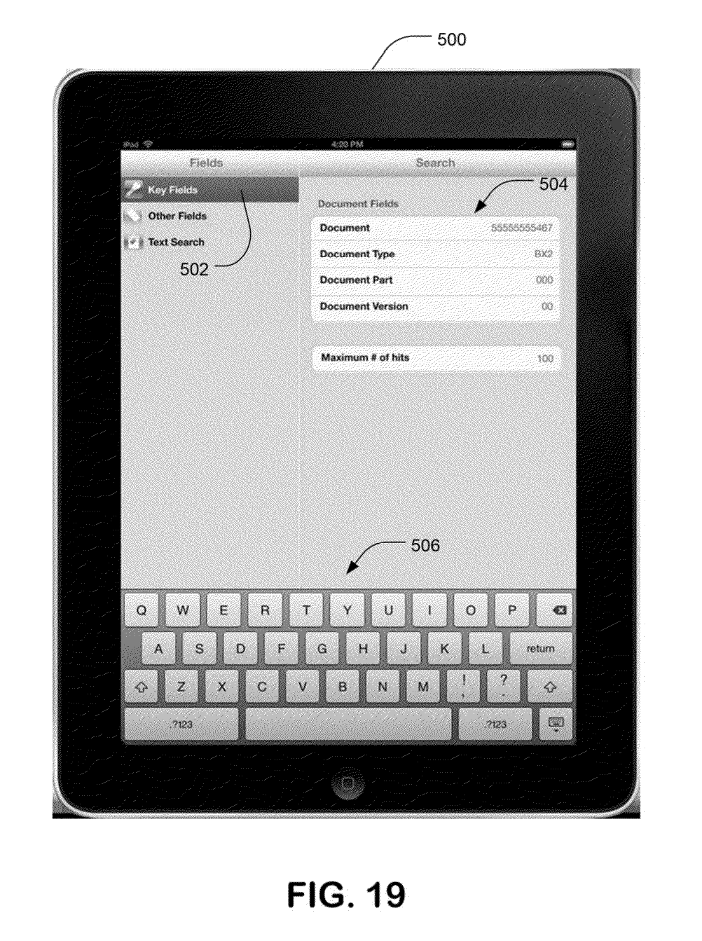

FIG. 19 illustrates a mobile device 500, which is similar to the mobile devices 104, 200 described hereinbefore, displaying one aspect of a “Key Fields” screen 502 comprising a “Document Fields” 504 portion and a keyboard 506 portion for manual data entry by the user. As shown, in one aspect, the “Document Fields” 504 portion provides the “Document” number (555555564567), “Document Type” (BX2), “Document Part” (000), and “Document Version” (00).

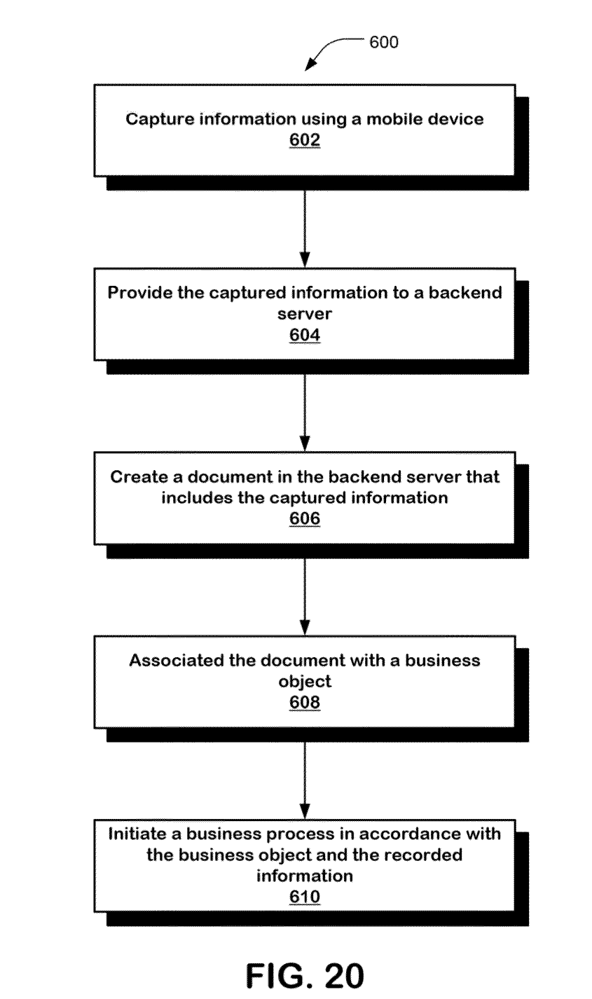

FIG. 20 is a diagram of a computer-implemented process 600 for connecting a mobile device with a backend server and initiating a business process. With reference now to FIGS. 1 and 20, in accordance with the computer-implemented process 600, at 602, multimedia information 102 such as video 102a, still images 102b, audio 102c, GPS data 102d, and other information 102n such as text, animation, and interactivity content forms, among others, is captured by the mobile device 200. Once captured, the information 102 is converted to one or more corresponding files suitable for transmission across the wireless network 106 and network 108. At 604, the files corresponding to the captured information 102, the mobile device 102 transmits or provides the files to the backend server 110 via the communication networks 106, 108. Once the backend server 110 receives the files from the mobile device 102, at 606 the backend server 110 creates a document 118 and stores the files (e.g., File 1, File 2, File 3, File 4, File n) received by the backend server 110 into the document 118. The document 118 may be stored in the database 116. At 608, the document 118 is associated with a business object 120. As discussed hereinbefore, the business object 120 is associated with a number of business functions such as order processing, procurement, production scheduling, customer information management, and accounting. More particularly, the business object 120 may be an equipment master, a materials master, a customer master, a vendor master, a service notification, a bill of materials, or any business object within the context of the enterprise application software environment. The business object 120 comprises key fields and contains information in the form of metadata that associates the document 118 with the business object 120. Once the document 118 is associated with the business object 120, at 610, a business process is initiated in accordance with the business object 120 and the information 102 recorded by the mobile device 102, which is now replicated in the files stored in the document 118.

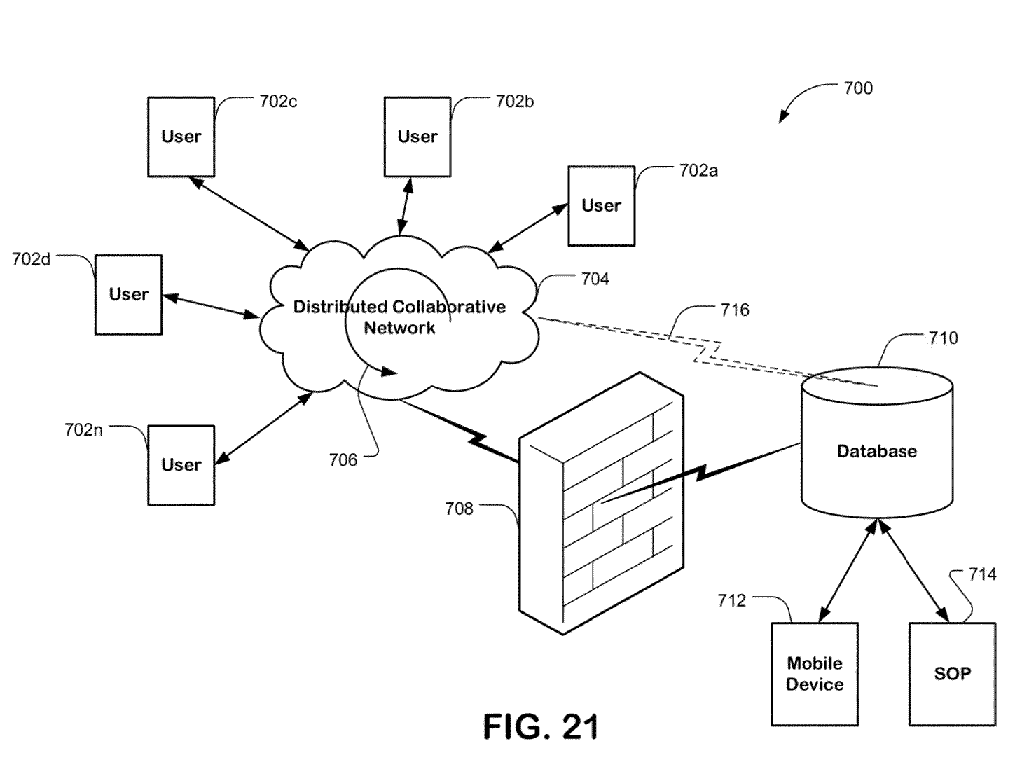

FIG. 21 is a diagram of one aspect of a system 700 associated with a distributed collaborative network 704. Two or more users 702 connected to the distributed collaborative network 704 can engage in a collaboration cycle 706. The distributed collaborative network 704 may be SAP® StreamWork™ by SAP®, Google®, or other similar social networks that bring together people, information, and business methods to achieve a common result.

During the collaboration cycle 706, the users 702 can only share information from a backend database 710 through a firewall 708 to protect sensitive information that should be kept secret from some of the users 702. For example, the backend database 710 may contain standard operating procedures 714 (SOP) of an enterprise, which cannot be made public to partners, vendors, and customers of the enterprise that are participating in the collaboration cycle 706.

Nevertheless, from time to time, there is a need to share some of the information contained in the backend database 710 by the users 702a-n to make the collaboration cycle 706 more productive. Information 716 from the backend database 710 can essentially be made available to the users 702a-n, provided that at least one user 702a has access to the database 710 through the firewall 708 without providing access to the backend database 710 to the other users. In one aspect, this may be accomplished by publishing a copy of the sensitive information 716 to be used only within the distributed collaborative network 704 such a StreamWork™ by SAP®. The user 702a that has access to the database 710 through the firewall 708 accesses the database 710 and publishes a copy of the sensitive information 716 to the other users 702b-n in the collaboration cycle 706 without giving them access to the backend database 710.

In one aspect, the backend database 710 includes information captured by a mobile device 712, as described hereinbefore in connection with FIGS. 1-20. Accordingly, information from the mobile device 712 can be stored in the backend database 710. During a collaboration cycle 706, the user 702a with access to the backend database 710 can publish a copy of the information 716 and make it available just to the users 702a-n engaged in the collaboration cycle without giving users 702b-n access to the backend database 710.

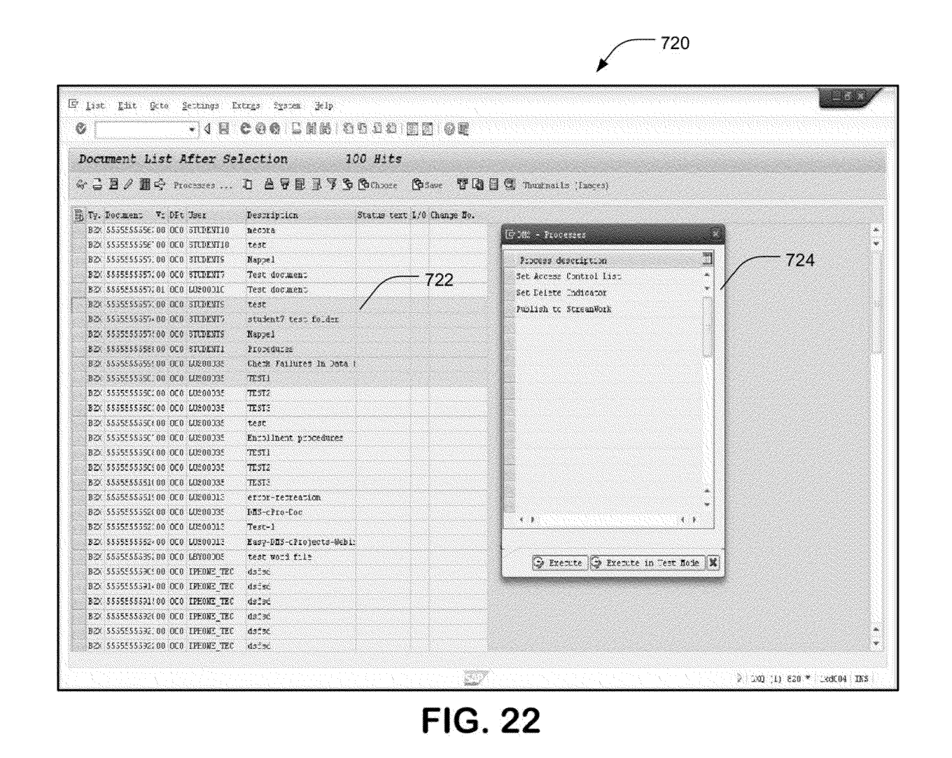

FIG. 22 illustrates a graphical screen 720 displayed by the backend server 110 (FIG. 1) on the display 114 (FIG. 1) coupled to the backend server 110. The graphical screen 720 shows a document list 722 after selection. In one aspect the DIRs from the SAP® Document Management System (DMS) may be sent to StreamWork™ by SAP®, Google® and any other cloud based information systems: (1) from a CV04N transaction and (2) by selecting items in the Application List Viewer (ALV) and then calling the DMS Processes functionality (e.g., by clicking the button Processes) both in “Execute” and “Execute in Test mode,” for example. In one aspect, the DIRs are sent from the SAP® DMS to StreamWork™, Google® and any other cloud based information systems by using settings stored in a DMS table, where the table contains the reference (name of function module) which handles of “Publish to StreamWork™” action item in the “DMS-Processes” dialog box 724.

FIG. 23 illustrates an example environment 1010 for implementing various aspects of the backend server 110 shown in FIG. 1. In one aspect, the example environment 1010 may comprise a computer system 1012, as part of the backend server 110 apparatus, system, and method for connecting mobile devices 104 (FIG. 1) to the backend server 110 in an enterprise software environment. The computer system 1012 includes a processor 1014, a system memory 1016, and a system bus 1018. The system bus 1018 couples system components including, but not limited to, the system memory 1016 to the processor 1014. The processor 1014 can be any of various available processors. Dual microprocessors and other multiprocessor architectures also can be employed as the processor 1014.

The system bus 1018 can be any of several types of bus structure(s) including the memory bus or memory controller, a peripheral bus or external bus, and/or a local bus using any variety of available bus architectures including, but not limited to, 9-bit bus, Industrial Standard Architecture (ISA), Micro-Charmel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), Small Computer Systems Interface (SCSI) or other proprietary bus.

The system memory 1016 includes volatile memory 1020 and nonvolatile memory 1022. The basic input/output system (BIOS), containing the basic routines to transfer information between elements within the computer system 1012, such as during start-up, is stored in nonvolatile memory 1022. For example, the nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. Moreover, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The computer system 1012 also includes removable/non-removable, volatile/non-volatile computer storage media. FIG. 23 illustrates, for example a disk storage 1024. The disk storage 1024 includes, but is not limited to, devices like a magnetic disk drive, floppy disk drive, tape drive, Jaz drive, Zip drive, LS-60 drive, flash memory card, or memory stick. In addition, the disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface 1026 is typically used.

It is to be appreciated that FIG. 10 describes software that acts as an intermediary between users and the basic computer resources described in a suitable operating environment 1010. Such software includes an operating system 1028. The operating system 1028, which can be stored on the disk storage 1024, acts to control and allocate resources of the computer system 1012. System applications 1030 take advantage of the management of resources by the operating system 1028 through program modules 1032 and program data 1034 stored either in the system memory 1016 or on the disk storage 1024. It is to be appreciated that various components described herein can be implemented with various operating systems or combinations of operating systems.

A user enters commands or information into the computer system 1012 through input device(s) 1036. The input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processor 1014 through the system bus 1018 via interface port(s) 1038. The interface port(s) 1038 include, for example, a serial port, a parallel port, a game port, and a universal serial bus (USB). The output device(s) 1040 use some of the same type of ports as input device(s) 1036. Thus, for example, a USB port may be used to provide input to the computer system 1012 and to output information from the computer system 1012 to an output device 1040. An output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

The computer system 1012 can operate in a networked environment using logical connections to one or more remote computers, such as the remote computer(s) 1044. The remote computer(s) 1044 can be a personal computer, a server, a router, a network PC, a workstation, a microprocessor based appliance, a peer device or other common network node and the like, and typically includes many or all of the elements described relative to the computer system 1012. For purposes of brevity, only a memory storage device 1046 is illustrated with the remote computer(s) 1044. The remote computer(s) 1044 is logically connected to the computer system 1012 through a network interface 1048 and then physically connected via a communication connection 1050. The network interface 1048 encompasses communication networks such as local-area networks (LAN) and wide area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

The communication connection(s) 1050 refers to the hardware/software employed to connect the network interface 1048 to the bus 1018. While the communication connection 1050 is shown for illustrative clarity inside the computer system 1012, it can also be external to the computer system 1012. The hardware/software necessary for connection to the network interface 1048 includes, for example, internal and external technologies such as, modems including regular telephone grade modems, cable modems and DSL modems, ISDN adapters, and Ethernet cards.

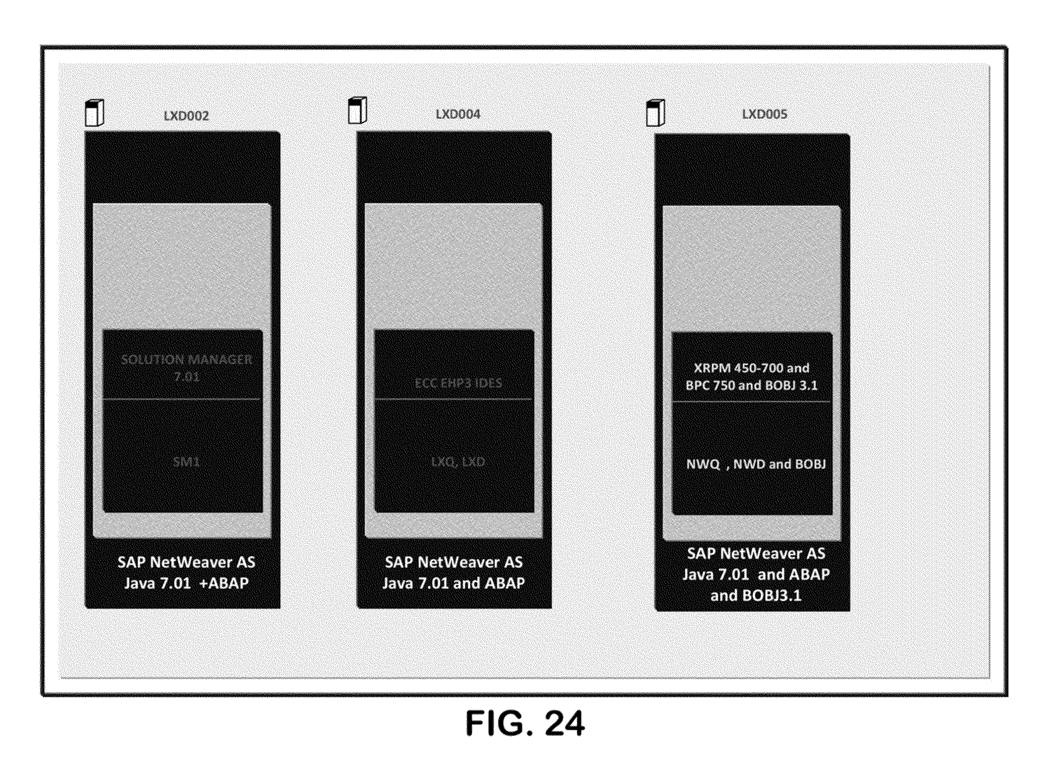

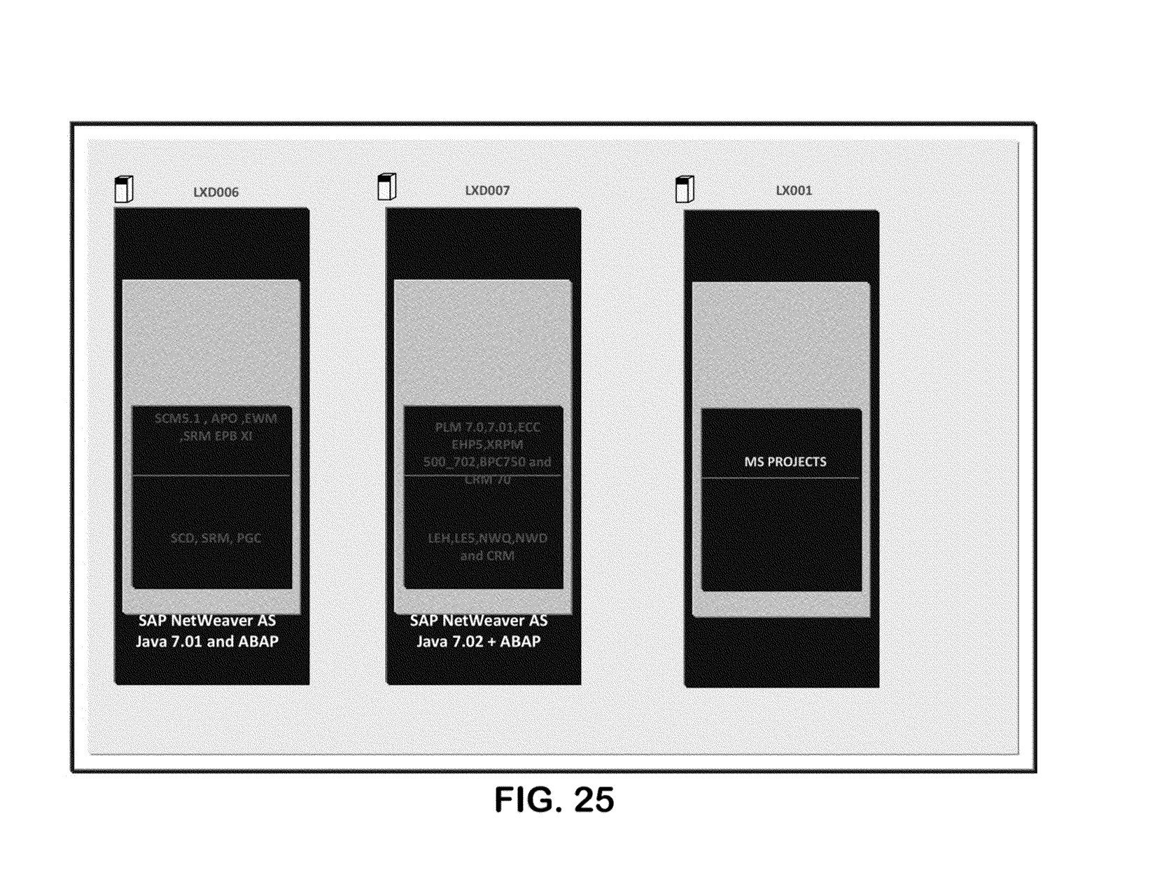

FIGS. 24 and 25 illustrate specific implementations of the backend server 110 environment shown in FIG. 1. Accordingly, the various computer-implemented methods disclosed hereinbefore can be implemented on a backend structure substantially as disclosed in FIGS. 24 and 25.

As used herein, the terms “component,” “system” and the like can also refer to a computer-related entity, either hardware, a combination of hardware and software, software, or software in execution, in addition to electro-mechanical devices. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The various illustrative functional elements, logical blocks, modules, and circuits described in connection with the aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format.

The functions of the various functional elements, logical blocks, modules, and circuits elements described in connection with the aspects disclosed herein may be performed through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, DSP hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The various functional elements, logical blocks, modules, and circuits elements described in connection with the aspects disclosed herein may comprise a processing unit for executing software program instructions to provide computing and processing operations for the computer and the industrial controller. Although the processing unit may include a single processor architecture, it may be appreciated that any suitable processor architecture and/or any suitable number of processors in accordance with the described aspects. In one aspect, the processing unit may be implemented using a single integrated processor.

The functions of the various functional elements, logical blocks, modules, and circuits elements described in connection with the aspects disclosed herein may be implemented in the general context of computer executable instructions, such as software, control modules, logic, and/or logic modules executed by the processing unit. Generally, software, control modules, logic, and/or logic modules include any software element arranged to perform particular operations. Software, control modules, logic, and/or logic modules can include routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some aspects also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the aspects described herein illustrate example implementations, and that the functional elements, logical blocks, modules, and circuits elements may be implemented in various other ways which are consistent with the described aspects. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual aspects described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one aspect” or “an aspect” means that a particular feature, structure, or characteristic described in connection with the aspect is included in at least one aspect. The appearances of the phrase “in one aspect” or “in one aspect” in the specification are not necessarily all referring to the same aspect.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some aspects may be described using the expression “coupled” and “connected” along with their derivatives. These terms are not intended as synonyms for each other. For example, some aspects may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and aspects as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or aspects disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the aspects have been illustrated as described above, many modifications, substitutions, changes and equivalents will now occur to those skilled in the art. It is therefore to be understood that the appended claims are intended to cover all such modifications and changes as fall within the scope of the disclosed aspects.

1. A computer-implemented method for initiating a business process at a backend server, the backend server comprising a processor, a memory, and an input/output interface for receiving and transmitting information to and from the processor, the method comprising:
receiving information captured by a mobile device at the backend server;
storing the captured information received by the backend server in the memory in the form of at least one file; and
initiating a business process in accordance with the captured information stored in the memory.

2. The computer-implemented method of claim 1, comprising:
creating a document by the backend server with the captured information stored in the memory; and
associating the document with a business object.

3. The computer-implemented method of claim 2, comprising initiating the business process in accordance with the business object and the captured information stored in the memory.

4. The computer-implemented method of claim 2, wherein the business object is associated with a business function selected from the group consisting of order processing, procurement, production scheduling, customer information management, and accounting, and any combination thereof.

5. The computer-implemented method of claim 4, wherein the business object is associated with an enterprise application software environment and is selected from the group consisting of an equipment master, a materials master, a customer master, a vendor master, a service notification, and a bill of materials, and any combination thereof.

6. The computer-implemented method of claim 1, wherein the captured information is selected from the group consisting of media, multimedia, and content, and any combination thereof.

7. The computer-implemented method of claim 2, further comprising controlling a graphical user interface of the mobile device by the business process to display information consistently with the business object.

8. The computer-implemented method of claim 7, wherein the under the control of the business process, information is captured by the mobile device in accordance with an underlying enterprise software environment executing at the backend server.

9. A method for connecting a mobile device to a backend server in an enterprise application software environment, the mobile device comprising a display, an image capture device, and a user interface, the method comprising:
displaying an objects screen on the display of the mobile device, wherein the objects screen provides an element to be selected that is associated with at least one business object to be created and/or linked to a document in a backend server in communication with the mobile device to perform a predetermined business function; and
receiving an input from the user interface associated with a selected element.

10. The method of claim 9, further comprising:
displaying a description screen based on the selected element; and
displaying at least one field associated with the selected element.

11. The method of claim 10, further comprising creating classifications in an information record of the document, wherein the at least one field is linked to at least one corresponding field of the at least one business object.

12. The method of claim 11, further comprising:
displaying a link description screen on the display of the mobile device;
linking the document to the selected element; and
adding media files to the at least one business object.

13. The method of claim 12, further comprising:
capturing information by the mobile device;
displaying content representing the captured information on the display; and

14. The method of claim 12, further comprising uploading the media files to backend server.

15. A distributed collaborative method executable in a distributed collaborative network in communication with a backend server comprising a backend database, the method comprising:
a plurality of users connecting to the distributed collaborative network, wherein at least one user has access to the backend database through a firewall;
initiating a collaboration cycle between the plurality of users; and
sharing a copy of information from the backend database between the at least one user having access to the backend database through a firewall and at least one other user connected to the distributed collaborative network that does not have access to the backend database.

16. The method of claim 15, further comprising publishing the copy of information within the distributed collaborative network by the at least one user having access to the backend database during the collaboration cycle without giving access to the backend database to the at least one other user connected to the distributed collaborative network that does not have access to the backend database.

17. The method of claim 15, further comprising receiving information captured by a mobile device at the backend server.

18. The method of claim 17, further comprising storing the received captured information in the backend database.

19. The method of claim 18, further comprising:
accessing the received captured information stored in the backend database by the at least one user through the firewall; and
retrieving the captured information stored in the backend database by the at least one user.

20. The method of claim 19, further comprising publishing a copy of the received captured information by the at least one user within the distributed collaborative network to the at least one other user that does not have access to the backend database.

21. An article comprising a computer-readable storage medium containing instructions that when executed by a processor enable a backend server to:
receive information captured by a mobile device at the backend server;
store the captured information received by the backend server in the memory in the form of at least one file; and
initiate a business process in accordance with the captured information stored in the memory.

22. An article comprising a computer-readable storage medium containing instructions that when executed by a processor enable a mobile device to:
display an objects screen on the display of the mobile device, wherein the objects screen provides an element to be selected that is associated with at least one business object to be created and/or linked to a document in a backend server in communication with the mobile device to perform a predetermined business function; and
receive an input from the user interface associated with a selected element.

23. An article comprising a computer-readable storage medium containing instructions that when executed by a processor enable a distributed collaborative network system to:
connect a plurality of users to the distributed collaborative network system, wherein at least one user has access to the backend database through a firewall;
initiate a collaboration cycle between the plurality of users; and
share a copy of information from the backend database between the at least one user having access to the backend database through a firewall and at least one other user connected to the distributed collaborative network that does not have access to the backend database.
